(19) United States
(12) Patent Application Publication
(10) Pub. No.: US 2007/0269778 A1
(43) Pub. Date: Nov. 22, 2007

(54) Learning system

(76) Inventor: Ben Sexton, South Natick, MA (US)

Correspondence Address: Iandiorio & Teska, 260 Bear Hill Road, Waltham, MA, 02451-1018, US

(21) Appl. No.: 11/435,022

(22) Filed: May 16, 2006

(51) Int. Cl. G09B 19/00

(52) U.S. Cl. 434/156

(57) ABSTRACT

A learning system comprising a database for storing predetermined articles having embedded linguistic hypertext links, vocabulary, grammatical rules, and grammatical data; a software engine configured to display a selected article from the predetermined articles and generate selectable teaching tools such that the selection of a teaching tool from the selectable teaching tools results in the selected article displaying embedded linguistic hypertext links associated with the selected teaching tool; and wherein the selection of one or more of the embedded linguistic hypertext links in the article provides a contextual explanation that teaches a student the conventions of standard written English.

### FIELD OF THE INVENTION

This invention relates generally to learning systems and more particularly to an improved computer-based learning system for teaching a student the conventions of standard written English.

### BACKGROUND OF THE INVENTION

Conventional computer-based learning systems that teach vocabulary, grammar, sentence structure, and the like rely on methods in which the student progresses through a number of instructional sessions and exercises that build on one another as the student advances to new, more complicated topics. However, conventional learning systems teach grammar, sentence structure, and vocabulary in isolation. Many contextual examples may be used, but the examples and the topics are typically of little or no interest to the student. Hence, the lessons learned in the examples are not memorable to the student.

Conventional learning systems also provide limited ability to track the student's performance based on a student's use of the various teaching modules and tests. Conventional learning systems do not provide student profiling modules that can track the student's selection of various vocabulary words in a vocabulary teaching tool, the student's selection of various grammatical teaching tools, the tests the student has taken, and, the difficulty level associated with the various tools and tests. Conventional profiling modules also cannot track the student's performance during a particular learning session or the student's overall performance with the learning system. Thus, conventional learning systems cannot intelligently recommend what the student needs to learn, the difficulty level of lessons the student should engage in, and what the student needs to review based on results of previous performances. Prior art learning systems are also typically expensive and complicated to use.

### BRIEF SUMMARY OF THE INVENTION

It is therefore an object of this invention to provide an improved learning system.

It is a further object of this invention to provide such a learning system which is more interesting to a student.

It is a further object of this invention to provide such a learning system which increases the amount a student learns and remembers.

It is a further object of this invention to provide such a learning system which integrates the teaching of vocabulary, grammar, sentence structure, and writing style.

It is a further object of this invention to provide such a learning system which more accurately tracks the performance progress of a student.

It is a further object of this invention to provide such a learning system which provides for student profiling.

It is a further object of this invention to provide such a learning system which is easy to use and less expensive.

The invention results from the realization that an improved learning system that is more interesting and enhances the learning experience for the student is effected with a database that stores predetermined articles having embedded linguistic hypertext links in which the articles are interesting to the student, e.g., sport articles, outdoor activity articles, fashion articles, political issues articles, and the like; and a software engine that displays a selected predetermined article with the embedded linguistic hypertext links and provides selectable teaching tools, such as vocabulary, grammar, sentence structure, and style, that the student selects; the software engine then displays the article with the embedded linguistic hypertext links that are associated with the selected teaching tool and the student selects various embedded linguistic hypertext links in the article that provide contextual explanations that teach the student the various conventions of standard written English.

The subject invention, however, in other embodiments, need not achieve all these objectives and the claims hereof should not be limited to structures or methods capable of achieving these objectives.

This invention features a learning system including a database for storing predetermined articles having embedded linguistic hypertext links, vocabulary, grammatical rules, and grammatical data; a software engine configured to display a selected article from the predetermined articles and generate selectable teaching tools such that the selection of a teaching tool from the selectable teaching tools results in the selected article displaying embedded linguistic hypertext links associated with the selected teaching tool; and wherein the selection of one or more of the embedded linguistic hypertext links in the article provides a contextual explanation that teaches a student the conventions of standard written English.

In a preferred embodiment, the predetermined articles may include an article chosen from the group consisting: of a sports article, a fashion article, an outdoor activity article, a celebrity news article, and a political issues article. The selectable teaching tools may include a teaching tool chosen from the group consisting of: vocabulary, grammar, sentence structure, and style. The database may store a word bank of vocabulary words, roots associated with each word in the word bank, student profile data, and tests. The software engine may display the article with the embedded linguistic hypertext links and the contextual explanation of the embedded linguistic hypertext link in an explanation window. The explanation window may include one or more hypertext links that provide a contextual explanation of the root and/or roots associated with each word in the word bank, and/or hypertext links to tutorial topics, tutorial subtopics, tutorial sub-subtopics and tests. The tutorial topics may include a tutorial topic chosen from the group consisting of subject and verb agreement, verb tenses, pronouns, punctuation, links, clauses, effective sentence structure, modification, comparisons, and style. Each of the tutorial subtopics and tutorial sub-subtopics may include one or more hypertext links that when selected may generate a tutorial explanation window with contextual text that further explains a selected tutorial subtopic and/or sub-subtopic. Each of the subtopics and tutorial sub-subtopics may include a difficulty level. Each word in the word bank may include a difficulty level and a rarity level. The learning system may further include a student profiles module for tracking the performance of a student. The student profiles module may generate a student profile by tracking the embedded linguistic hypertext links a student has or has not selected while reading one or more of the predetermined articles. The student profiles module may also track the tutorial subtopics and tutorial sub-subtopics the student has selected. The student profiles module may further track one or more tests taken by the student.

### BRIEF DESCRIPTION OF THE DRAWINGS

Other objects, features and advantages will occur to those skilled in the art from the following description of a preferred embodiment and the accompanying drawings, in which:

FIG. 1 is a schematic block diagram of one embodiment of the learning system of this invention;

FIG. 2 is a view of a window showing various hypertext links for exemplary articles, tutorials and student profiling in accordance with this invention;

FIG. 3 is a view of various windows generated by the learning system of this invention when the vocabulary teaching tool shown in FIG. 1 is selected;

FIG. 4 is a view of various windows generated by the learning system of this invention when the grammar teaching tool shown in FIG. 1 is selected;

FIG. 5 is a view of various windows generated by the learning system of this invention when the sentence structure teaching tool shown in FIG. 1 is selected;

FIG. 6 is a view of various windows generated by the learning system of this invention when the style teaching tool shown in FIG. 1 is selected;

FIG. 7 is a view showing exemplary tutorial topics in accordance with this invention; and

FIGS. 8A-8C are views showing in further detail the tutorial subtopics and sub-subtopics for the tutorial topics shown in FIG. 7.

Although specific features of this invention are shown in some drawings and not others, this is for convenience only as each feature may be combined with any or all of the other features in accordance with the invention.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

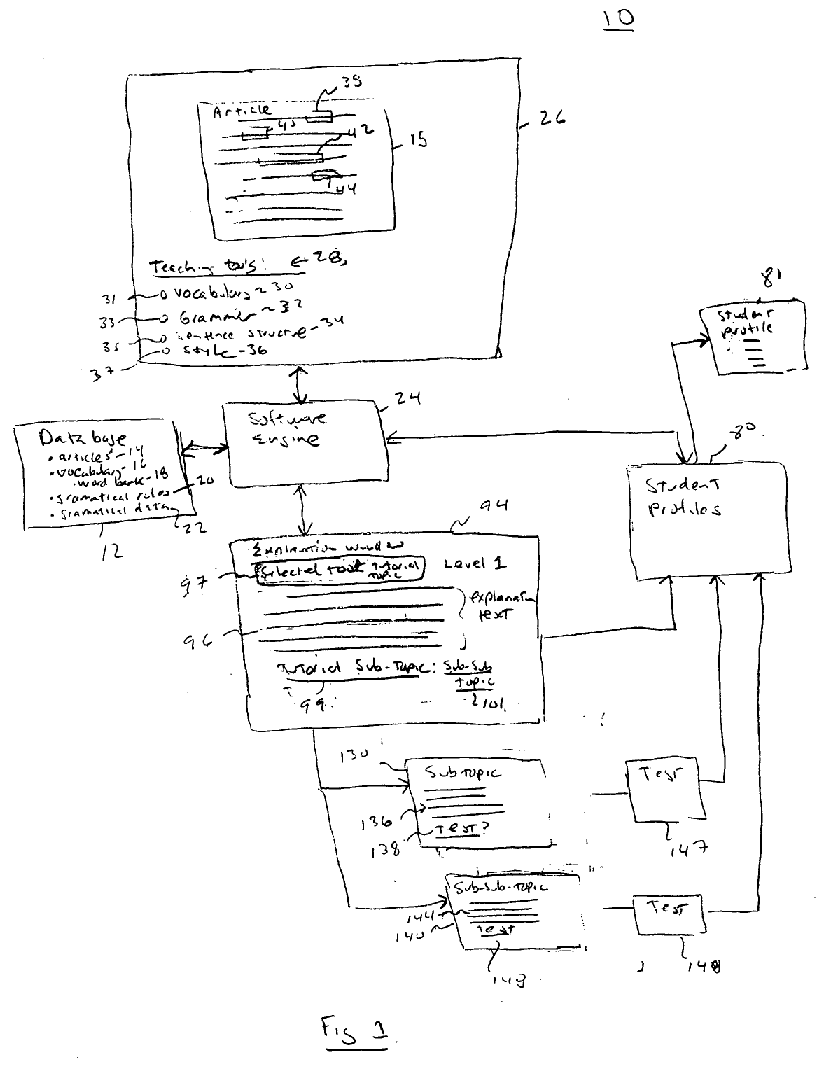

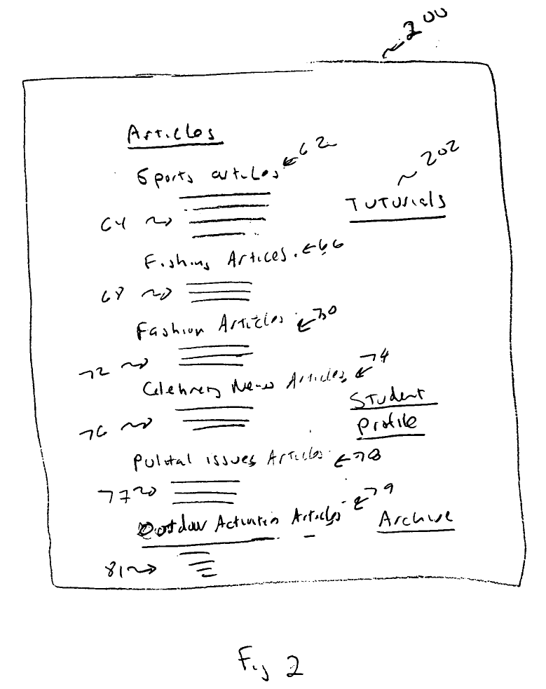

There is shown in FIG. 1, learning system 10 of this invention that includes database 12 for storing articles 14 with embedded linguistic hypertext links, vocabulary 16 with word bank 18, grammatical rules 20, and grammatical data 22. Software engine 24 is configured to read database 12 and display a selected one of articles 14, e.g., article 15, in window 26. Software engine 24 generates and displays selectable teaching tools 28, such as vocabulary teaching tool 30, grammar teaching tool 32, sentence structure teaching tool 34, and style teaching tool 36 in window 26. Teaching tools 30, 32, 34, and 36 are selected by clicking on the respective radio buttons 31, 33, 35 and 37. Articles 14 stored in database 12 are selected by the student and displayed as article 15 with embedded linguistic hypertext links 38, 40,42 and 44 (discussed below) in window 26. Articles 14 are chosen to be interesting to the student to enhance the learning experience for the student and increase the likelihood the lessons learned using learning system 10 will be remembered. Window 200, FIG. 2 shows examples of the various types of articles 14 that may be selected by clicking on the associated hypertext links for a particular article. For example, the student may select one of sports articles 62, fishing articles 66, fashion articles 70, celebrity news articles 74, political issues articles 78, or outdoor activities articles 79 by clicking on one of associated hypertext links 64, 68, 72, 76, 77, and 81, respectively. However, learning system 10 is not limited to the types of articles discussed above, as other articles that may be interesting to the student may also be utilized in accordance with this invention.

Once the student has selected an article of interest in window 200, software engine 24, FIG. 1, displays the article as article 15 in window 26. The student then chooses one of teaching tools 30-36. In response, software engine 24 generates and displays article 15 with embedded linguistic hypertext links 38, 40, 42 and 44 that are associated with the selected teaching tool. The selection of one of embedded linguistic hypertext links 38-44 results in software engine 24 generating explanation window 94 that includes explanation text 96 that provides an explanation of the selected embedded linguistic hypertext link that teaches the student the conventions of written English.

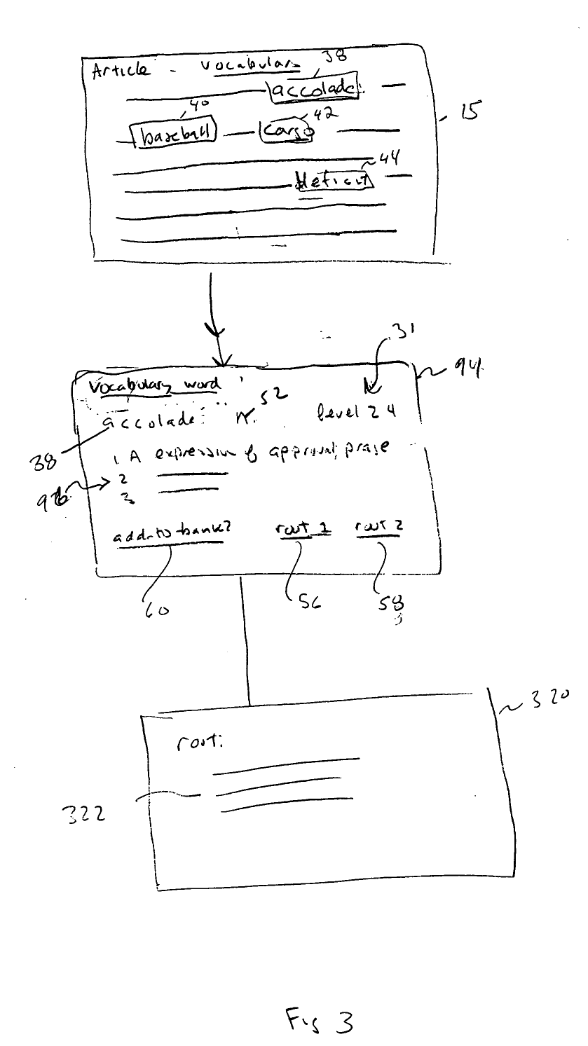

For example, selecting vocabulary teaching tool 30 drives software engine 24 to read database 12 and generate and display article 15 with embedded linguistic hypertext links 38-44 that are related to vocabulary, e.g., words in word bank 18. In this example, article 15, FIG. 3, shows embedded linguistic hypertext links 38-44 that include the vocabulary words “accolade”, “baseball”, “cargo”, and “deficit”, respectively. The selection of one of embedded linguistic hypertext links 38-44, e.g., link 38 for the word “accolade”, results in software engine 24 generating explanation window 94 with explanation text 96 that provides a definition of “accolade”. Explanation window 94 also displays the selected link 38 and the type of word it is, e.g., a noun, indicated as “n” at 50. The difficulty level and rarity level of the selected word is also provided in explanation window 94. In this example, level 24, indicated at 31, shows a difficulty level of 2 and a rarity level of 4 for the word “accolade” (discussed in further detail below). In this example, software engine 24 also generates root hypertext link 56 and root hypertext link 58 in explanation window 94 that when selected provide an explanation of the root and/or roots associated with the selected word “accolade”, as shown by explanation text 322 in explanation window 320. Add-to-bank hypertext link 60 provides the ability for the student to add the particular selected word to the user's word bank for later review. Although as shown above article 15 includes hypertext links 38-44, this is not a necessary limitation of this invention, article 15 may have any number of embedded linguistic hypertext links, as known to those skilled in the art.

The result is that learning system 10 of this invention provides the student with the ability to read an article that the student finds interesting, e.g., sports articles, fishing articles, or fashion articles, and the like, and while reading the interesting article the student clicks on various embedded linguistic hypertext links for words in the article the student does not understand. Learning system 10 then provides a detailed definition of the word and the roots of the word. Because the article is interesting to the student, the student is more likely to remember the word and the student learns vocabulary in an interesting and efficient manner. However, learning system 10 is not limited to teaching vocabulary. As shown below, improved learning system 10 integrates the teaching of vocabulary, grammar, sentence structure, and style to teach the student the conventions of standard written English.

Learning system 10 also provides extensive tutorials for grammar, sentence structure and style. For example, explanation window 94, FIG. 1, includes hypertext links to tutorials related to a selected teaching tool, such as selected teaching tool tutorial topic hypertext link 97, tutorial subtopic hypertext link 99 and tutorial sub-subtopic hypertext link 101. The selection of one of hypertext links 97-101 causes software engine 24 to generate one or more detailed explanation windows related to the selected tutorial topic, subtopic, or sub-subtopic. For example, selecting tutorial subtopic hypertext link 99 generates explanation window 130 with explanation text 136 that explains in detail the selected tutorial subtopic (discussed below). Explanation window 130 also includes test hypertext link 138 that generates test 147 related to teaching tool tutorial subtopic hypertext link 99 (discussed below). Similarly, the selection of tutorial sub-subtopic hypertext link 101 generates explanation window 140 that includes explanation text 144 that provides a detailed explanation of the tutorial sub-subtopic. The selection of selected teaching tool tutorial subtopic hypertext link 99 generates a window that includes hypertext links to all the various tutorial topics related to the selected teach tool (discussed below).

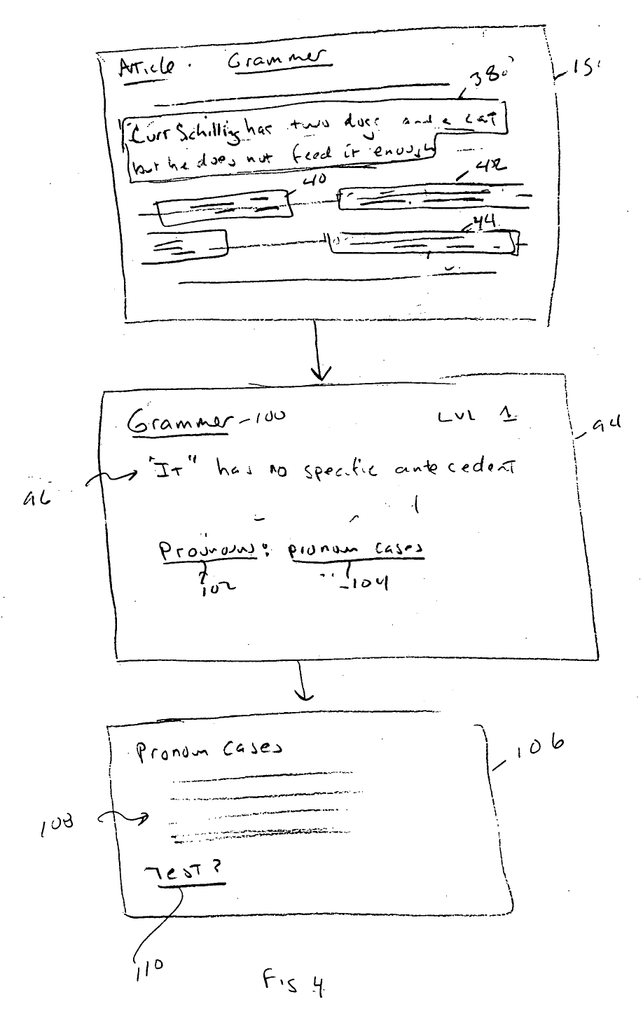

The selection of grammar teaching tool 32, FIG. 1, generates article 15, FIG. 4, with embedded linguistic hypertext links 38-44 that are now related to grammar. In this example, embedded linguistic hypertext links 38-44 reflect grammatical expressions that teach the student the conventions of standard written English. For example, embedded linguistic hypertext link 38 shows the example: “Curt Schilling has two dogs and a cat but he does not feed it enough.” When the student selects link 38, software engine 24 provides explanation window 94 with explanation text 96 that indicates the grammatical problem with link 38, namely, the word “it” has no specific antecedent. As discussed above, explanation window 94 also includes hypertext links to tutorials related to grammar teaching tool 32, such as grammar hypertext link 100, pronoun tutorial subtopic hypertext link 102 and pronoun cases tutorial sub-subtopic hypertext link 104. The selection of one of tutorial subtopic hypertext links 102 or 104, e.g., pronoun cases hypertext link 104, generates explanation window 106 with explanation text 108 that explains further details of the grammatical rules related to the selected tutorial hypertext link. The selection of grammar hypertext link 100 generates all the available tutorial topics, subtopics and sub-subtopics related to grammar teaching tool 32 (discussed in further detail below). Explanation window 106 also includes test link 110 that generates a test related to the selected tutorial subtopic or sub-subtopic.

Similarly as described above for vocabulary, learning system 10 of this invention allows the student to read an interesting article and click on various embedded linguistic hypertext links in the article related to grammar that the student does not understand. Learning system 10 then provides a detailed an explanation of the selected link that teaches the student the grammatical rule related to the selected embedded linguistic hypertext link. If the student still does not understand the particular grammatical concept, learning system 10 provides tutorials broken down by tutorial subtopics and sub-subtopics that provide detailed explanations of the grammatical rule. The result is that the student learns the conventions of standard written English in an interesting and memorable manner.

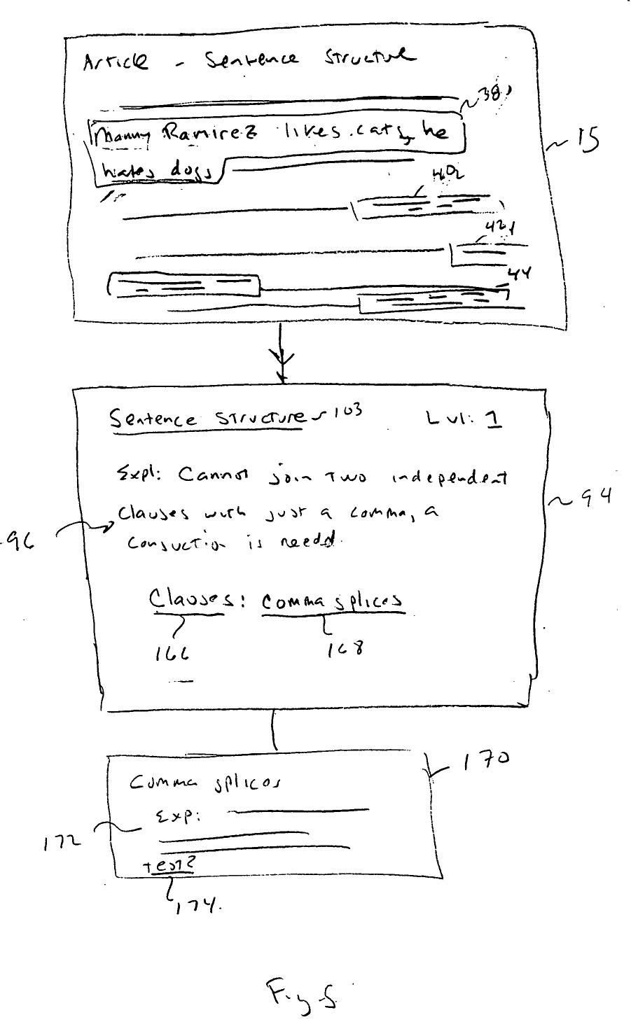

The selection of sentence structure teaching tool 34, FIG. 1, generates article 15, FIG. 5 with embedded linguistic hypertext links 38-44 that are related to sentence structure. For example, embedded linguistic hypertext link 38 now shows the example: “Manny Ramirez likes cats, he hates dogs”. When the student selects link 38, software engine 24 generates explanation window 94 with explanation text 96 that indicates the problem with the sentence structure in embedded linguist hypertext link 38, namely, “one cannot join two independent clauses with just a comma, a conjunction is needed”. Similar as described above, explanation window 94 includes hypertext links for tutorials related to sentence structure teaching tool 34 and hypertext links for tutorial subtopics and sub-subtopics, e.g., hypertext link 166 for clauses tutorial subtopic and hypertext link 168 for comma splices tutorial sub-subtopic that can be selected by the student to provide further explanation related to the selected hypertext link. In this example, comma splices tutorial sub-subtopic hypertext link 168 is selected to generate explanation window 170 with explanation text 172 that provides further explanation about comma splices. Test hypertext link 174 generates a test related to comma splices (discussed below).

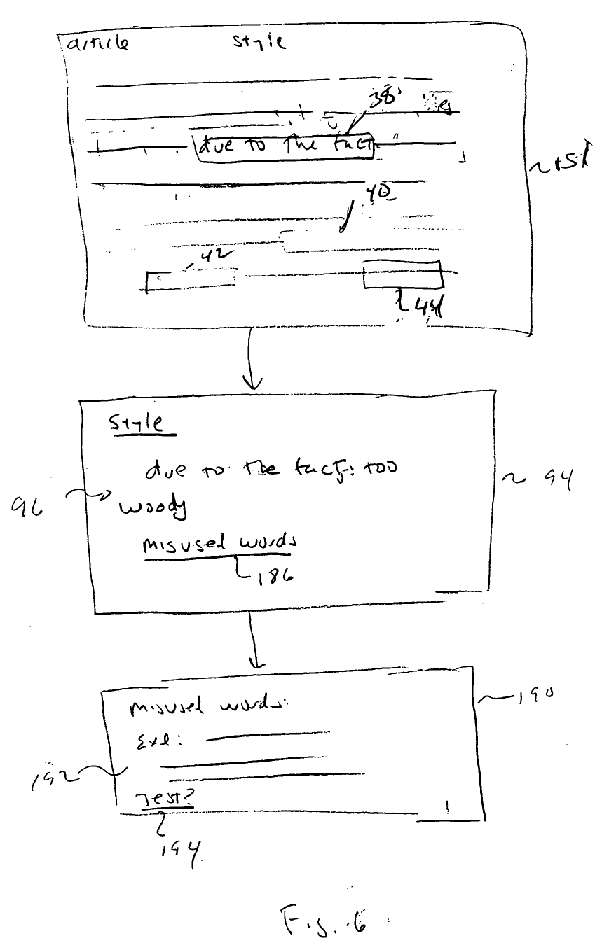

The selection of style teaching tool 36, FIG. 1 generates article 15, FIG. 6, with embedded linguistic hypertext links 38-44 that are related to style. In this example, embedded linguistic hypertext link 38 displays the example “Due to the fact”. The selection of embedded linguistic hypertext link 38 generates explanation window 94 with explanation text 96 that indicates “due to the fact” is too wordy. Similar as described above, explanation window 94 includes hypertext links to tutorial topics, subtopics and sub-subtopics, e.g., hypertext link 186 for misused words tutorial subtopic, that generates explanation window 190 with explanation text 192. Window 190 also includes test hypertext link 194 that generates a test related to misused words.

The result of a student reading various interesting articles and selecting the various teaching tools described above is that the student learns vocabulary, grammar, sentence structure, and style, i.e., the conventions of standard written English in an integrated, interesting and memorable manner. Learning system 10 is easy to use, inexpensive and may be used by students preparing for standardized examinations, such as the Scholastic Aptitude Test (SAT), and the like.

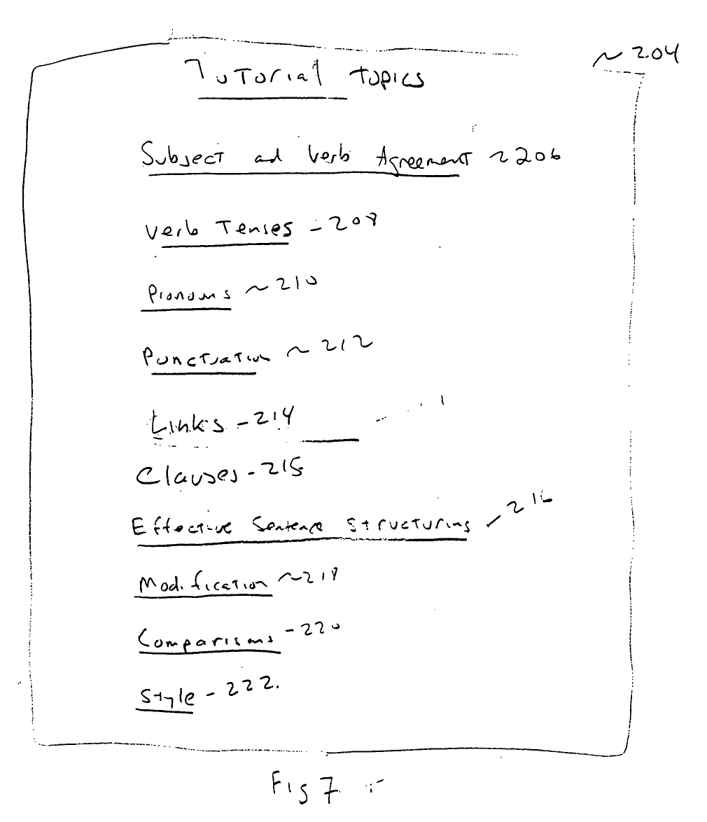

Although as discussed above the various tutorials are typically selected from within an explanation window, this is not a necessary limitation of this invention, as the student may choose any tutorial topic by selecting tutorials hypertext link 202, FIG. 2. Selection of hypertext link 202 generates window 204, FIG. 7, with hypertext links for the various tutorial topics of learning system 10. Exemplary hypertext linked tutorial topics include subject and verb agreement 206, verb tenses 208, pronouns 210, punctuation 212, links 214, clauses 215, effective sentence structuring 216, modification 218, comparisons 220 and style 222. Each of tutorial topics 206-222 are related to a one of teaching tools 30-36 described above and are hypertext linked to tutorial subtopics and tutorial sub-subtopics that provide detailed explanations for the selected topic.

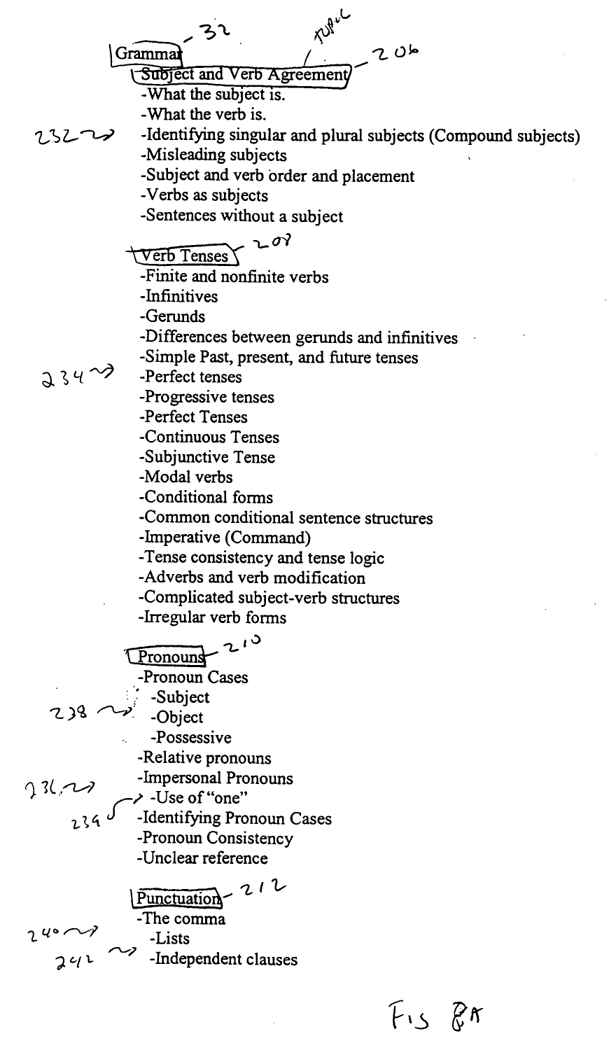

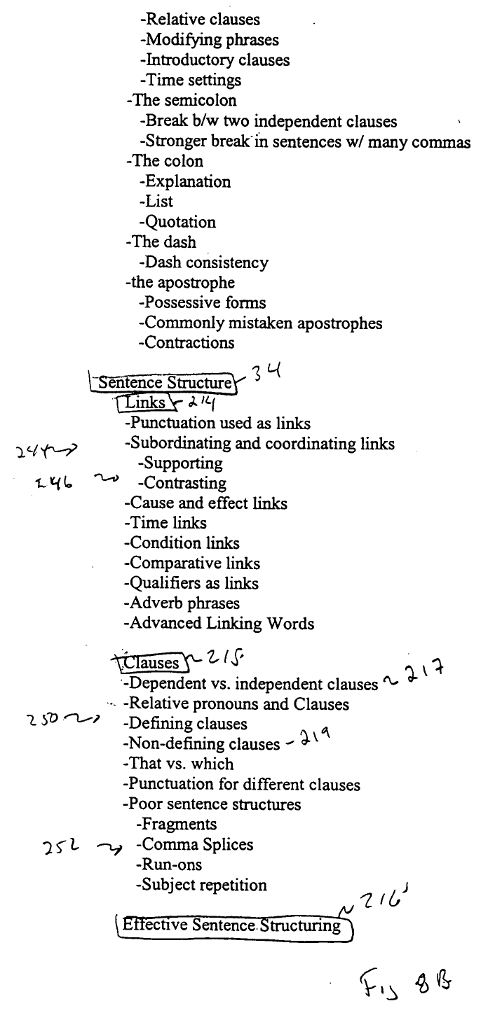

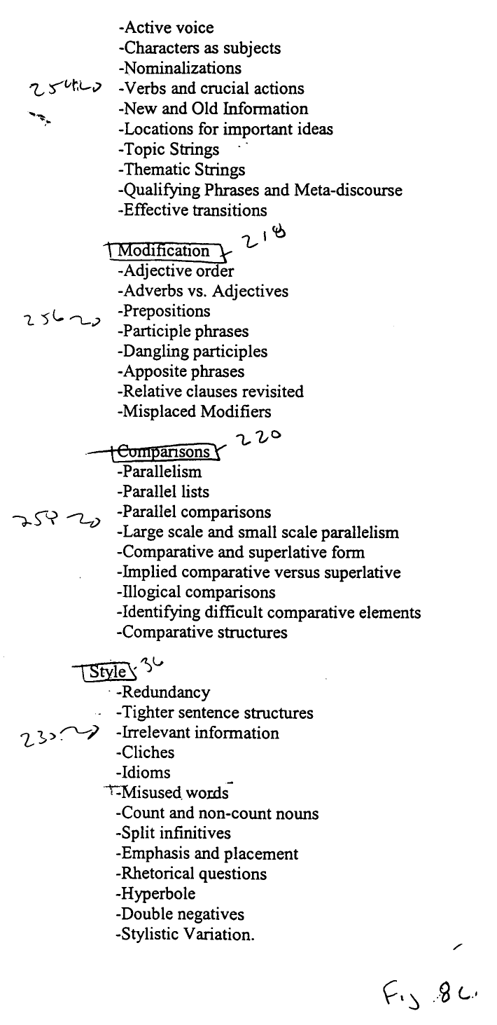

For example, tutorial topics for the grammar teaching tool are shown in FIG. 8A and include subject and verb agreement tutorial topic 206, verb tenses tutorial topic 208, pronouns tutorial topic 210, and punctuation tutorial topic 212. Subject and verb agreement tutorial topic 206 includes hypertext linked tutorial subtopics 232. Similarly, verb tenses tutorial topic 208 includes hypertext linked tutorial subtopics 234. Pronouns tutorial topic 210 includes hypertext linked tutorial subtopics 236 and hypertext linked tutorial sub-subtopics, such as tutorial sub-subtopics 238 and 239. Punctuation tutorial topic 212 includes hypertext linked tutorial subtopics 240 and hypertext linked tutorial sub-subtopics 242. Although not shown, subject and verb agreement tutorial topic 206 and verb tenses tutorial topic 208 may also include hypertext links for tutorial sub-subtopics. Selection of the any of the various hypertext links for the tutorial subtopics or sub-subtopics described above generates an explanation window that provides detailed explanation text of the selected tutorial hypertext link that enhances the learning experience of the student.

The tutorial topics for the sentence structure teaching tool 34 are shown in FIG. 8B and include hypertext links for links tutorial topic 214, clauses tutorial topic 215, effective sentence structuring tutorial topic 216, modification tutorial topic 218, and comparisons tutorial topic 220. Similarly, links tutorial topic 214 includes hypertext linked tutorial subtopics 244 and hypertext linked tutorial sub-subtopics 246. Clauses tutorial topic 215 includes hypertext linked tutorial subtopics 250 and hypertext linked tutorial sub-subtopics 252. Appendix A attached hereto shows an example of the clauses tutorial topic 215 and the selection of“Dependent vs. independent clauses” tutorial subtopic hypertext link 217. As shown in Appendix A, detailed explanation 297 of the selected tutorial subtopic is provided by learning system 10. A detailed explanation of the selection of “non-defining clauses” hypertext link 219 is also shown in Appendix A at 299. Appendix A is for exemplary purposes only and is not a necessary limitation of this invention, as learning system 10 provides detailed explanations for all the tutorial subtopics and sub-subtopics described herein. Effective sentence structuring tutorial topic 216, FIG. 8B includes hypertext linked tutorial subtopics 254 that include hypertext linked tutorial sub-subtopics (not shown). Modification tutorial topic 218 includes hypertext linked tutorial subtopics 256 and may include hypertext linked sub-subtopics links (not shown). Comparisons tutorial topic 220 includes hypertext linked tutorial subtopics 258 and may include hypertext linked tutorial sub-subtopics (not shown).

Tutorial topics for the style teaching tool are shown in FIG. 8C and include hypertext linked tutorial subtopics 230 and may also hypertext linked for tutorial sub-subtopics (not shown).

As discussed above database 12, FIG. 1, stores vocabulary 16 that includes Word bank 18 of vocabulary words. Database 12 also stores roots related to each word in word bank 18 and the difficulty and rarity level of each word in word bank 18. Appendix B attached hereto shows one example of the various words that are stored in word bank 18 and the difficulty level and rarity level associated with each word stored in word bank 18. For example, the word “acute”, indicated at 302 has a difficulty level of 2, indicated at 304, and a rarity level of 3, indicated at 306. As discussed above, when vocabulary teaching tool 30, FIG. 1, is selected, window 26 is generated with article 15 that includes embedded linguistic hypertext links 38-44 that are words from word bank 18. As discussed above and shown in FIG. 3, the selection of one of embedded linguistic hypertext links 38-44 that are words results in explanation window 94 with explanation text 96 that provides the definition of the selected word. Selecting one of roots hypertext links 56 or 58 generates explanation window 320 with explanation text 322 that explains the root of the selected word. Appendix C attached hereto shows exemplary roots that are displayed in explanation window 320 in accordance with this invention.

Student profiles module 80, FIG. 1, tracks the selection of various vocabulary words displayed as embedded linguistic hypertext links 38-44, FIG. 3, that are selected by the student while reading article 15. Student profiles module 80 tracks all the selected and non-selected embedded linguistic hypertext links 38-44 in all the articles the student has read and assumes the student knows the words in embedded linguistic hypertext links 38-44 the student did not select. Table 1 below shows an example of a student profile generated by student profiles module 80 during a typical learning session with learning system 10 when the vocabulary tool has been selected.

TABLE 1
Table 1: A student's profile for the vocabulary teaching tool.

| | Words | | | |
|---|---|---|---|---|
| Level | Viewed | Words Clicked | Percentage Clicked | Strength |
| Level 1 | 30 | 2 | 6.7% (93.3% Known) | Strong |
| Level 2 | 50 | 5 | 10% (90% Known) | Strong |
| Level 3 | 70 | 19 | 27.1% (72.9% Known) | Moderate |
| Level 4 | 60 | 28 | 46.7% (53.3% Known) | Weaker |
| Level 5 | 50 | 34 | 68% (32% Known) | Weak |
| Level 6 | 40 | 32 | 80% (20% Known) | Weak |
| Level 7 | 30 | 28 | 93.3% (6.7% Known) | Weak |
| Total | 330 | 158 | 47.8% (52.2% Known) | Level 3-4 |

Student profiles module 80 similarly tracks the performance of the student when grammar teaching tool 32 is selected by tracking the various embedded linguistic hypertext links 38-44 related to grammar that the student has or has not selected while reading various selected articles 14 displayed as article 15 and similarly assumes the student understands the hypertext links not selected. Table 2 below shows a sample student profile generated by student profiles module 80 of the student's selection of various embedded linguistic hypertext links from an article the student has read while using the grammar teaching tool. In this example, embedded linguistic hypertext links 38-44 are pronouns and student profiles module 80 tracks how many pronoun embedded linguistic hypertext links the student has selected in all the articles the student has read with learning system 10. Student profiles module 80 compares that number to the total number of embedded linguistic hypertext links 38-44 displayed in the various articles the student has read. The common subtopics column displays the common subtopic that the student has clicked on the most often.

TABLE 2
Table 2: A student's profile for the grammar teaching tool.

| | Instances | Correct | Percentage | Common | Level |
|---|---|---|---|---|---|
| | Viewed | Choices | Correct | Subtopics | Strength |
| Level 1 | 20 | 19 | 95% | None - Level | Strong |
| | | | | Mastered | |
| Level 2 | 30 | 27 | 90% | Impersonal | Strong |
| | | | | Pronouns | |
| Level 3 | 40 | 34 | 85% | Identifying | Skilled |
| | | | | Pronoun Cases | |
| Level 4 | 35 | 24 | 68.5% | Identifying | Weaker |
| | | | | Pronoun Cases | |
| Level 5 | 25 | 10 | 40% | Relative | Weak |
| | | | | Pronouns | |
| Overall | 150 | 114 | 76% | Relative | Level 4 |
| | | | | Pronouns | |

Student profiles module 80, FIG. 1, also tracks the students overall performance during all the learning sessions with teaching tools 30-36 by tracking all of the selected and non-selected embedded linguistic hypertext links 38-44 in all the articles is the student has read. Student profiles module 80 also tracks all the tutorial subtopics and sub-subtopics selected by the student. Table 3 below is an example of a student's profile generated by student profiles module 80 that shows the student's overall performance with learning system 10. Column 1 indicates the various tutorial topics chosen, column 2 indicates the teaching tool selected, followed by the total choices presented to the student, e.g., all the embedded linguistic hypertext links presented in all the articles read by the student, correct choices (e.g., all the embedded linguistic hypertext links in all the articles read by the student that the student did not select), incorrect choices (e.g., the all the embedded linguistic hypertext links the student selected), the percentage correct (not selected), the tutorial subtopic, and the student's strength. One example of the ratings for the student is as follows: 90 to 100% equals strong; 80 to 90% equals skilled; 70-80% equals moderate; 50 to 70% equals weaker; and 0 to 50% equals weak.

TABLE 3
Table 3: A student's profile for the student's overall performance.

| | Teaching | Total | Correct | Incorrect | | | |
|---|---|---|---|---|---|---|---|
| Topic | Tool | Choices | Choices | Choices | Percentage | Study Topic(s) | Strength |
| Subject and | Grammar | 120 | 85 | 35 | 70.8% | Misleading | Moderate |
| Verb | | | | | | Subjects | |
| Agreement | | | | | | | |
| Verb Tenses | Grammar | 140 | 102 | 38 | 72.9% | Gerunds, | Moderate |
| | | | | | | Progressive | |
| | | | | | | Tenses | |
| Pronouns | Grammar | 130 | 77 | 53 | 59.2% | Possessive | Weaker |
| | | | | | | Pronouns, | |
| | | | | | | Relative Pronouns | |
| Punctuation | Grammar | 150 | 129 | 21 | 86.0% | Semicolons | Skilled |
| Links | Sent. | 110 | 72 | 38 | 65.4% | Qualifiers as | Moderate |
| | Structure | | | | | Links | |
| Clauses | Sent. | 90 | 49 | 41 | 54.4% | Adverb Clauses, | Weaker |
| | Structure | | | | | Comma Splices | |
| Effective | Sent. | 105 | 68 | 37 | 64.8% | Nominalizations, | Weaker |
| Sentence | Structure | | | | | Verbs and | |
| Structuring | | | | | | Crucial Actions | |
| Modification | Sent. | 70 | 46 | 24 | 65.7% | Dangling | Moderate |
| | Structure | | | | | Participles | |
| Comparisons | Sent. | 60 | 48 | 12 | 80% | Parallel | Skilled |
| | Structure | | | | | Comparisons | |
| Style | Style | 140 | 109 | 31 | 77.9% | Idioms, | Moderate |
| | | | | | | Redundancy | |
| Total | | 1115 | 797 | 318 | 71.5% | Possessive | Moderate |
| | | | | | | Pronouns, | |
| | | | | | | Idioms | |

Student profiles module 80 also generates student profiles similar to those shown in Table 3 above that track the student's performance while taking tests. Student profiles module 80 also tracks the student's performance for predefined periods of time, such as the past 30 days and past 60 days. This provides the student with the ability to compare the student's recent performance to his or her past performance. In a preferred design, student profiles module 80 generates bar graphs (not shown) representing the overall percentages in a particular topic, subtopic, or sub-subtopic.

As discussed above, the selection of any of the hypertext links from the various tutorial subtopics and tutorial sub-subtopics provides a detailed explanation in the explanation window of the selected tutorial topic and also includes a test hypertext link for the student to take a test for the particular tutorial subtopic or sub-subtopic. Appendix D attached hereto shows several exemplary tests or practice problems incorporated by learning system 10 that are tracked by student profiles module 80. The tests are designed such that clicking on the highlighted embedded linguistic hypertext link in the test example signifies that the embedded linguistic hypertext link is incorrect and a non-click signifies the embedded linguistic hypertext link is correct. In either case (clicking or non-clicking), an explanation window is provided to the student that explains the particular test example. Appendix B attached hereto shows exemplary tests generated by learning system 10. For example, test 350 in Appendix D has a difficulty level of 1 (easier) and includes embedded linguistic hypertext link 352. Explanation window 354 is generated that provides explanation text 356 that explains embedded linguistic hypertext link 352 is correct and why it is correct. Appendix D is for exemplary purposes only and is not a necessary limitation of this invention, as learning system 10 includes practice tests for all of the tutorial subtopics and tutorial sub-subtopic discussed above.

The result is that learning system 10 of this invention provides an interesting and efficient method of teaching the student the conventions of standard English. Because interesting articles are read by the student, the lessons learned are more likely to be remembered. Learning system 10 integrates the learning of vocabulary, grammar, sentence structure, and style in an efficient and easy to use manner. The innovative tracking module provides student profiles that show the student which area the student needs to focus on and how the student is progressing.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A learning system comprising:
a database for storing predetermined articles having embedded linguistic hypertext links, vocabulary, grammatical rules, and grammatical data;
a software engine configured to display a selected article from the predetermined articles and generate selectable teaching tools such that the selection of a teaching tool from the selectable teaching tools results in the selected article displaying embedded linguistic hypertext links associated with the selected teaching tool; and
wherein the selection of one or more of the embedded linguistic hypertext links in the article provides a contextual explanation that teaches a student the conventions of standard written English.

2. The learning system of claim 1 in which the predetermined articles include an article chosen from the group consisting: of a sports article, a fashion article, an outdoor activity article, a celebrity news article, and a political issues article.

3. The learning system of claim 1 in which the selectable teaching tools include a teaching tool chosen from the group consisting of: vocabulary, grammar, sentence structure, and style.

4. The learning system of claim 1 in which the database stores a word bank of vocabulary words, roots associated with each word in the word bank, student profile data, and tests.

5. The learning system of claim 1 in which the software engine displays the article with the embedded linguistic hypertext links and the contextual explanation of the embedded linguistic hypertext links in an explanation window.

6. The learning system of claim 5 in which the explanation window includes one or more hypertext links that provide a contextual explanation of the root and/or roots associated with each word in the word bank.

7. The learning system of claim 5 in which the explanation window includes hypertext links to tutorial topics, tutorial subtopics, tutorial sub-subtopics and tests.

8. The learning system of claim 7 in which the tutorial topics include a tutorial topic chosen from the group consisting of subject and verb agreement, verb tenses, pronouns, punctuation, links, clauses, effective sentence structure, modification, comparisons, and style.

9. The learning system of claim 8 in which each of the tutorial subtopics and tutorial sub-subtopics includes one or more hypertext links that when selected generate a tutorial explanation window with contextual text that further explains a selected tutorial subtopic and/or sub-subtopic.

10. The learning system of claim 9 in which each of the subtopics and tutorial sub-subtopics includes a difficulty level.

11. The learning system of claim 4 in which each word in the word bank includes a difficulty level and a rarity level.

12. The learning system of claim 1 further includes a student profiles module for tracking the performance of a student.

13. The learning system of claim 12 in which the student profiles module generates a student profile by tracking the embedded linguistic hypertext links a student has or has not selected while reading one or more of the predetermined articles.

14. The learning system of claim 12 in which the student profiles module tracks the tutorial subtopics and tutorial sub-subtopics the student has selected.

15. The learning system of claim 12 in which the student profiles module tracks one or more tests taken by the student.
